(19) United States
(12) Patent Application Publication
(10) Pub. No.: US 2010/0017197 A1
(43) Pub. Date: Jan. 21, 2010

(54) VOICE CODING DEVICE, VOICE DECODING DEVICE AND THEIR METHODS

(75) Inventor: Masahiro Oshikiri, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/447,667

(22) PCT Filed: Nov. 1, 2007
(86) PCT No.: PCT/JP2007/071339

§ 371 Date: Jun. 2, 2009

(30) Foreign Application Priority Data
Nov. 2, 2006 (JP) 2006-299520

(51) Int. Cl. G10L 19/02; G10L 21/00

(52) U.S. Cl. 704/205; 704/219; 704/500; 704/E19.002; 704/E19.023

(57) ABSTRACT

It is an object to disclose a voice coding device, etc. in which the deterioration of a voice quality of a decoded signal can be reduced in the case that low frequency domain components of a spectrum are used for coding high frequency domain components and that no low frequency domain components exist. In this voice coding device, a frequency domain transform unit (101) generates an input spectrum from an input voice signal, a first layer coding unit (102) codes a lower frequency domain portion of the input spectrum to generate first layer coded data, a first layer decoding unit (103) decodes the first layer coded data to generate a first layer decoded spectrum, a lower frequency domain component judging unit (104) judges if there are low frequency domain components of the first layer decoded spectrum, and a second decoding unit (105); codes high frequency domain components of the input spectrum to generate second layer coded data in the case that the low frequency domain components exist and codes high frequency domain components by using a predetermined signal disposed in the low frequency domain components to generate second layer coded data in the case that the low frequency domain components do not exist.

### TECHNICAL FIELD

The present invention relates to a speech coding apparatus, speech decoding apparatus and speech coding and decoding methods.

### BACKGROUND ART

In a mobile communication system, speech signals are required to be compressed at a low bit rate for efficient uses of radio wave resources. Meanwhile, users demand improved quality of speech communication and realization of communication services with high fidelity. To realize these, it is preferable not only to improve the quality of speech signals, but also enable high quality coding of signals other than speech signals such as audio signals having a wider band.

To meet such contradictory demands, an approach of integrating a plurality of coding techniques in a layered manner attracts attention. To be more specific, studies are underway on a configuration combining in a layered manner the first layer for encoding an input signal at a low bit rate by a model suitable for a speech signal, and the second layer for encoding the residual signal between the input signal and the first layer decoded signal by a model suitable for signals other than speech. In a coding scheme adopting such a layered structure, a bit stream acquired from a coding section has a feature of “scalability,” meaning that, even when part of the bit stream is discarded, a decoded signal with certain quality can be acquired from the rest of the bit stream, and, the coding scheme is therefore referred to as “scalable coding.” Scalable coding having such a feature can flexibly support communication between networks having different bit rates, and is therefore suitable for a future network environment in which various networks are integrated by IP (Internet Protocol).

An example of conventional scalable coding techniques is disclosed in Non-Patent Document 1. Non-Patent document 1 discloses scalable coding using the technique standardized by moving picture experts group phase-4 (“MPEG-4”). To be more specific, in the first layer, code excited linear prediction (“CELP”) coding suitable for speech signals is used, and, in the second layer, transform coding such as advanced audio coding (“AAC”) and transform domain weighted interleave vector quantization (“TwinVQ”), is used for the residual signal acquired by removing the first layer decoded signal from the original signal.

Further, as for transform coding, Non-Patent document 2 discloses a technique of encoding the higher band of a spectrum efficiently. Specifically, Non-Patent Document 2 discloses utilizing the lower band of a spectrum as the filter state of the pitch filter and representing the higher band of a spectrum using an output signal of the pitch filter. Thus, by encoding filter information of a pitch filter with a small number of bits, it is possible to realize a lower bit rate.
Non-patent document 1: “Everything for MPEG-4 (first edition),” written by Miki Sukeichi, published by Kogyo Chosakai Publishing, Inc., Sep. 30, 1998, pages 126 to 127
Non-Patent Document 2: “Scalable speech coding method in 7/10/15 kHz band using band enhancement techniques by pitch filtering,” Acoustic Society of Japan, March 2004, pages 327 to 328

### DISCLOSURE OF INVENTION

### Problem to be Solved by the Invention

However, with the method of efficiently encoding the higher band of a spectrum utilizing the lower band of the spectrum, if a signal having higher band components alone (i.e. a signal having no lower band components) is received as input, there are no lower band components that are required to encode the higher band components, and, consequently, there is a problem that the higher band spectrum cannot be encoded.

FIG. 1 illustrates a method for efficiently encoding the higher band of a spectrum utilizing the lower band of the spectrum and illustrates a problem with the method. In this figure, the horizontal axis represents frequency, and the vertical axis represents energy. Further, hereinafter, the frequency band of 0≦k<FL will be referred to as the “lower band,” the frequency band of FL≦k<FH will be referred to as the “higher band,” and the frequency band of 0≦k<FH will be referred to as the “whole band.” Further, hereinafter, the process of encoding the lower band will be referred to as the “first coding process,” and the process of efficiently encoding the higher band of the spectrum utilizing the lower band of the spectrum will be referred to as the “second coding process.” FIGS. 1A to 1C illustrate a method of efficiently encoding the higher band of a spectrum utilizing the lower band of the spectrum if a speech signal having components over the whole band is received as input. FIGS. 1D to 1F illustrate a problem with the method of efficiently encoding the higher band of a spectrum utilizing the lower band of the spectrum if a speech signal having higher band components alone without lower band components is received as input.

FIG. 1A illustrates the spectrum of a speech signal having components over the whole band. The lower band of the spectrum of a decoded signal acquired by performing the first coding process using the lower band components of this speech signal, is limited to the frequency band of 0≦k<FL as shown in FIG. 1B. Further, when the second coding process is performed using the decoded signal illustrated in FIG. 1B, the spectrum of the resulting whole band decoded signal is as shown in FIG. 1C and is similar to the spectrum of the original speech shown in FIG. 1A.

On the other hand, FIG. 1D illustrates the spectrum of a speech signal including higher band components alone with lower band components. Here, a case will be explained using sine waves of frequency X0 (FL<X0<FH). Upon encoding the lower band as the first coding process, the input speech signal has no lower band components, and the lower band of the spectrum of the decoded signal is limited to the frequency band of 0≦k<FL. Therefore, as shown in FIG. 1E, the lower band of the decoded signal contains nothing, and the spectrum is lost over the whole band. Next, upon performing the second coding process using the lower band of the decoded signal, the spectrum of the resulting whole band decoded signal is as shown in FIG. 1F. Here, there are no lower band components, and consequently it is not possible to encode the higher band components correctly.

It is therefore an object of the present invention to provide a speech coding apparatus and so on that alleviate quality degradation of a decoded signal to efficiently encode the higher band of a spectrum utilizing the lower band of the spectrum even if there are no lower band components in part of a speech signal.

### Means for Solving the Problem

The speech coding apparatus of the present invention employs a configuration having: a first layer coding section that encodes components in a lower band of an input speech signal and acquires first layer encoded data, the lower band being lower than a predetermined frequency; a deciding section that decides whether or not there are the components in the lower band of the speech signal; and a second layer coding section that, if there are the components in the lower band of the speech signal, encodes components in a higher band of the speech signal using the components in the lower band of the speech signal and acquires second layer encoded data, the higher band being equal to or higher than the predetermined frequency, and that, if there are not the components in the lower band of the speech signal, encodes the components in the higher band of the speech signal using a predetermined signal allocated in the lower band of the speech signal and acquires second layer encoded data.

### ADVANTAGEOUS EFFECT OF THE INVENTION

According to the present invention, to efficiently encode the higher band of a spectrum utilizing the lower band of the spectrum, the higher band components of the speech signal are encoded using a predetermined signal allocated in the lower band of the speech signal if there are no lower band components of the speech signal, so that it is possible to alleviate the sound quality degradation of the decoded signal even when there are no lower band components in part of the speech signal.

### BRIEF DESCRIPTION OF DRAWINGS

FIG. 1 illustrates a method for efficiently encoding the higher band of a spectrum utilizing the lower band of the spectrum according to conventional techniques and illustrates a problem with the method;

FIG. 2 illustrates a process according to the present invention using a spectrum;

FIG. 3 is a block diagram showing main components of a speech coding apparatus according to Embodiment 1;

FIG. 4 is a block diagram showing main components of a second layer coding section according to Embodiment 1;

FIG. 5 is a block diagram showing main components of a speech decoding apparatus according to Embodiment 1;

FIG. 6 is a block diagram showing main components inside a second layer decoding section according to Embodiment 1;

FIG. 7 is a block diagram showing another configuration of a speech coding apparatus according to Embodiment 1;

FIG. 8 is a block diagram showing another configuration of a speech decoding apparatus according to Embodiment 1;

FIG. 9 is a block diagram showing main components of a second layer coding section according to Embodiment 2;

FIG. 10 is a block diagram showing main components inside a gain coding section according to Embodiment 2;

FIG. 11 illustrates gain vectors included in a second gain codebook according to Embodiment 2;

FIG. 12 is a block diagram showing main components inside a second layer decoding section according to Embodiment 2;

FIG. 13 is a block diagram showing main components inside a gain decoding section according to Embodiment 2;

FIG. 14 is a block diagram showing main components of a speech coding apparatus according to Embodiment 3;

FIG. 15 is a block diagram showing main components of a speech decoding apparatus according to Embodiment 3;

FIG. 16 is a block diagram showing main components of a speech coding apparatus according to Embodiment 4;

FIG. 17 is a block diagram showing main components inside a downsampling section according to Embodiment 4;

FIG. 18 illustrates how a spectrum changes in a case where a lower band pass filtering process is not performed and yet a extracting process is performed directly in a downsampling section according to Embodiment 4;

FIG. 19 is a block diagram showing main components of a second layer coding section according to Embodiment 4;

FIG. 20 is a block diagram showing main components of a speech decoding apparatus according to Embodiment 4;

FIG. 21 is a block diagram showing main components of a second layer decoding section according to Embodiment 4;

FIG. 22 is a block diagram showing another configuration of a downsampling section according to Embodiment 4; and

FIG. 23 illustrates how a spectrum changes in a case where a extracting process is performed directly in a downsampling section employing another configuration according to Embodiment 4.

### BEST MODE FOR CARRYING OUT THE INVENTION

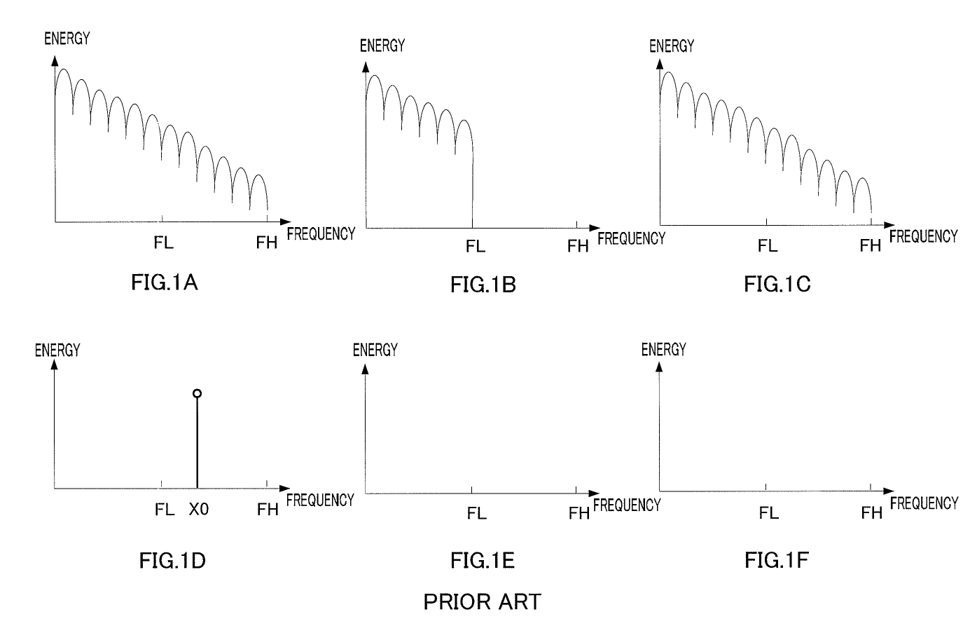

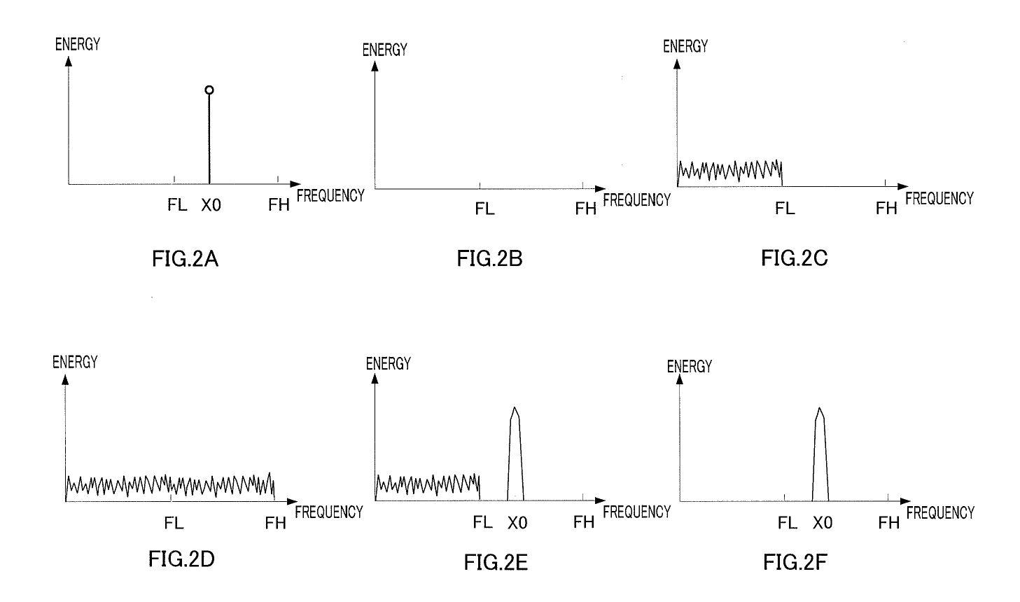

First, the principle of the present invention will be explained using FIG. 2. Here, as in FIG. 1D, an example case will be explained where sine waves of the frequency X0 (FL<X0<FH) are inputted.

First, in the first coding process on the coding side, the lower band of an input signal including only sine waves of the frequency X0 (FL<X0<FH) shown in FIG. 2A is encoded. The resulting decoded signal in the first coding process is as shown in FIG. 2B. The present invention decides whether or not there are lower band components in the decoded signal shown in FIG. 2B, and, upon deciding that there are no lower band components (or there are few lower band components), allocates a predetermined signal in the lower band of the decoded signal as shown in FIG. 2C. Here, it is possible to use a random number signal as a predetermined signal, and, furthermore, it is possible to encode sine waves more accurately by using components of high peak levels in the predetermined signal. Next, FIG. 2D illustrates the second coding process where the higher band of a spectrum is estimated using the lower band of the decoded signal, and gain coding of the higher band of the input signal is performed. Next, on the decoding side, the higher band is decoded using estimation information transmitted from the coding side, and, furthermore, a gain adjustment of the decoded signal in the higher band is performed using gain coding information to acquire the decoded spectrum shown in FIG. 2E. Next, based on coding information about the decision as to whether or not there are lower band components, zero values are assigned to the lower band of the input signal to acquire the decoded spectrum shown in FIG. 2F.

Embodiments of the present invention will be explained below in detail with reference to the accompanying drawings.

### Embodiment 1

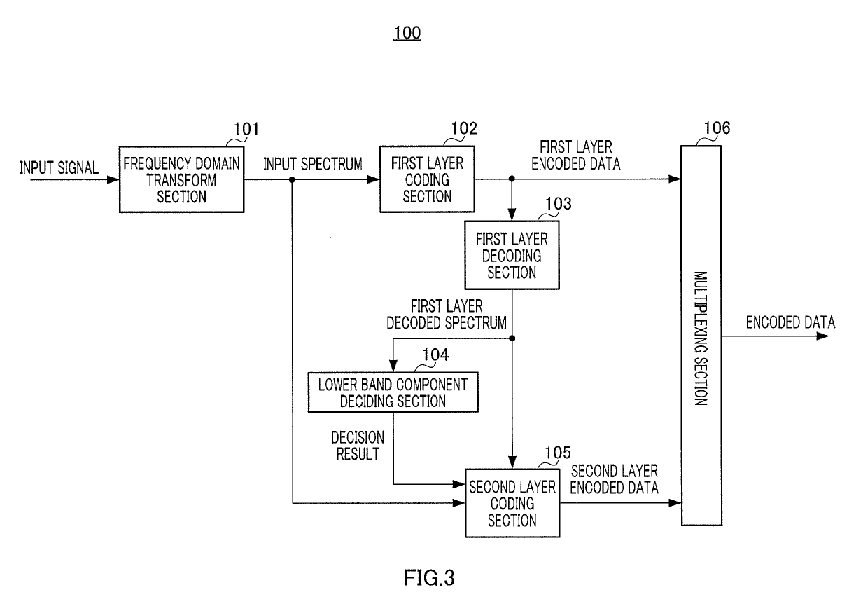

FIG. 3 is a block diagram showing main components of speech coding apparatus 100 according to Embodiment 1 of the present invention. Further, an example case will be explained below where coding is performed in the frequency domain in both the first layer and the second layer.

Speech coding apparatus 100 is provided with frequency domain transform section 101, first layer coding section 102, first layer decoding section 103, lower band component deciding section 104, second layer coding section 105 and multiplexing section 106. Further, in both the first layer and the second layer, coding is performed in the frequency domain.

Frequency domain transform section 101 performs an frequency analysis of an input signal and finds the spectrum of the input signal (i.e. input spectrum) S1(k) (0≦k<FH) in the form of transform coefficients. Here, FH represents the maximum frequency in the input spectrum. To be more specific, for example, frequency domain transform section 101 transforms a time domain signal into a frequency domain signal using the MDCT (Modified Discrete Cosine Transform). The input spectrum is outputted to first layer coding section 102 and second layer coding section 105.

First layer coding section 102 encodes the lower band 0≦k<FL (FL<FH) of the input spectrum using, for example, TwinVQ or AAC, and outputs the resulting first layer encoded data to first layer decoding section 103 and multiplexing section 106.

First layer decoding section 103 generates the first layer decoded spectrum S2(k) (0≦k<FL) by performing first layer decoding using the first layer encoded data, and outputs the first layer decoded spectrum to second layer coding section 105 and lower band component deciding section 104. Here, first layer decoding section 103 outputs the first layer decoded spectrum before being transformed into a time domain signal.

Lower band component deciding section 104 decides whether or not there are lower band components (0≦k<FL) in the first layer decoded spectrum S2(k) (0≦k<FL), and outputs the decision result to second layer coding section 105. Here, if it is decided that the there are lower band components, the decision result is “1,” and, if it is decided that there are no lower band components, the decision result is “0.” The decision method includes comparing the energy of the lower band components and a predetermined threshold, deciding that there are the lower band components if the lower band component energy is equal to or higher than the threshold, and determining that there are no lower band components if the lower band component energy is lower than the threshold.

Second layer coding section 105 encodes the higher band FL≦k<FH of the input spectrum S1(k) (0≦k<FH) outputted from frequency domain transform section 101 using the first layer decoded spectrum received from first layer decoding section 103, and outputs the second layer encoded data resulting from this coding to multiplexing section 106. To be more specific, second layer coding section 105 estimates the higher band of the input spectrum through a pitch filtering process using the first layer decoded spectrum as the filter state of the pitch filter. Further, second layer coding section 105 encodes filter information of the pitch filter. Second layer coding section 105 will be described later in detail.

Multiplexing section 106 multiplexes the first layer encoded data and the second layer encoded data, and outputs the resulting encoded data. This encoded data is superimposed over a bit stream via, for example, a transmission processing section (not shown) of a radio transmitting apparatus having speech coding apparatus 100, and is transmitted to a radio receiving apparatus.

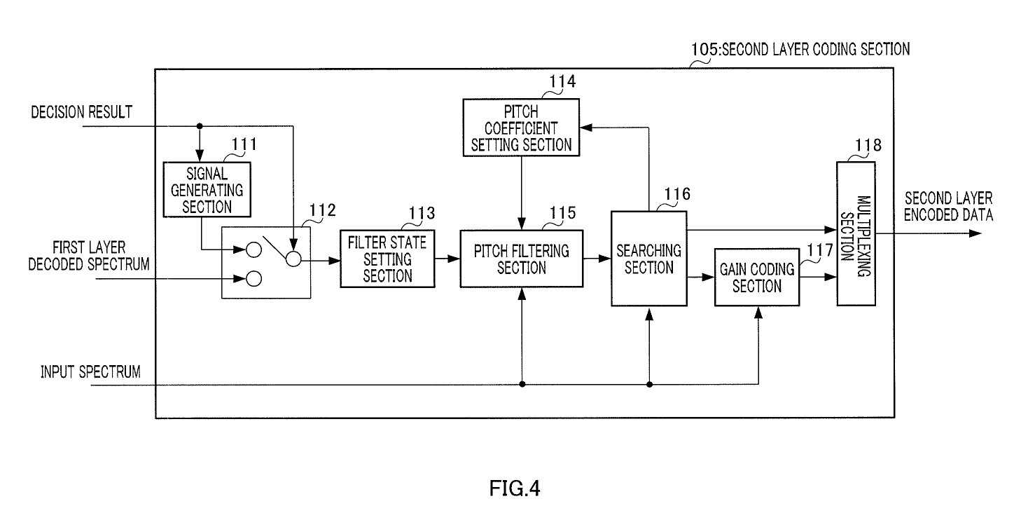

FIG. 4 is a block diagram showing main components inside second layer coding section 105 described above. Second layer coding section 105 is provided with signal generating section 111, switch 112, filter state setting section 113, pitch coefficient setting section 114, pitch filtering section 115, searching section 116, gain coding section 117 and multiplexing section 118, and these sections perform the following operations.

If the decision result received from lower band component deciding section 104 is “0,” signal generating section 111 generates a random number signal, a signal clipping a random number or a predetermined signal designed in advance by learning, and outputs the result to switch 112.

Switch 112 outputs the predetermined signal received from signal generating section 111 if the decision result received from lower band component deciding section 104 is “0,” while outputting the first layer decoded spectrum S2(k) (0≦k<FL) to filter state setting section 113 if the decision result is “1.”

Filter state setting section 113 sets the predetermined signal or first layer decoded spectrum S2(k) (0≦k<FL) received from switch 112, as the filter state used in pitch filtering section 115.

Pitch coefficient setting section 114 gradually and sequentially changes the pitch coefficient T in a predetermined search range between Tₘᵢₙ and Tₘₐₓ under the control of searching section 116, and outputs the pitch coefficients T's in order, to pitch filtering section 115.

Pitch filtering section 115 has a pitch filter and perform pitch filtering for the first layer decoded spectrum S2(k) (0≦k<FL) using the filter state set in filter state setting section 113 and the pitch coefficient T received from pitch coefficient setting section 114. Pitch filtering section 115 calculates estimated spectrum S1′(k) (FL≦k<FH) for the higher band of the input spectrum.

To be more specific, pitch filtering section 115 performs the following filtering process.

Pitch filtering section 115 generates the spectrum over the band FL≦k<FH using the pitch coefficients T's received from pitch coefficient setting section 114. Here, the spectrum over the entire frequency band (0≦k<FH) will be referred to as “S(k)” for ease of explanation, and the result of following equation 1 is used as the filter function.

$$P ( z ) = \frac{1}{1 - {\sum }_{i = - M}^{M} {β}_{i} {z}^{- T + i}} \qquad ( Equation 1 )$$

In this equation, T is the pitch coefficient given from pitch coefficient setting section 114, βᵢ is the filter coefficient, and M is 1.

The lower band 0≦k<FL of S(k) (0≦k<FH) accommodates the first layer decoded spectrum S2(k) (0≦k<FL) as the internal state of the filter (i.e. filter state).

By the filtering process shown in following equation 2, the higher band FL≦k<FH of S(k) (0≦k<FH) accommodates the estimated spectrum S1′(k) (FL≦k<FH) for the higher band of the input spectrum S1(k) (0≦k<FH).

$$S {1}^{′} ( k ) = {\sum }_{i = - 1}^{1} {β}_{i} \cdot S ( k - T + i ) \qquad ( Equation 2 )$$

That is, the spectrum S(k−T) of a frequency lowering k by T, is basically assigned to S1′(k). However, to make a spectrum smoother, in fact, it is equally possible to calculate nearby spectrum βᵢ·S(k−T+i), which is acquired by multiplying spectrum S(k−T+i) that is i apart from spectrum S(k−T), by predetermined filter coefficient βᵢ, add the resulting spectrums with respect to all i's, and assign the resulting spectrum to S1′(k).

By performing the above calculation with frequency k in the range of FL≦k<FH changed in order from the lowest frequency k=FL, the estimated spectrum S1′(k) (FL≦k<FH) for the input spectrum of the higher band FL≦k<FH is calculated.

The above filtering process is performed by zero-clearing S(k) in the range of FL≦k<FH every time filter coefficient setting section 114 gives the pitch coefficient T. That is, S(k) (FL≦k<FH) is calculated and outputted to searching section 116 every time the pitch coefficient T changes.

Searching section 116 calculates the similarity between the higher band (FL≦k<FH) of the input spectrum S1(k) received from frequency domain transform section 101 and the estimated spectrum S1′(k) (FL≦k<FH) received from pitch filtering section 115. This calculation of similarity is performed by, for example, correlation calculations. The processes in pitch coefficient setting section 114, pitch filtering section 115 and searching section 116 form a closed loop. Searching section 114 calculates the similarity associated with each pitch coefficient by variously changing the pitch coefficient T outputted from pitch coefficient setting section 114, and outputs the pitch coefficient whereby the maximum similarity is calculated, that is, outputs the optimal pitch coefficient T′ to multiplexing section 117 (where T′ is in the range between Tₘᵢₙ and Tₘₐₓ). Further, searching section 116 outputs the estimated spectrum S1′(k) (FL≦k<FH) associated with this pitch coefficient T′ to gain coding section 117.

Gain coding section 117 calculates gain information of the input spectrum S1(k) based on the higher band FL≦k<FH of the input spectrum S2(k) received from frequency domain transform section 101. To be more specific, gain information is represented by dividing the frequency band FL≦k<FH into J subbands and using the spectrum amplitude information of each subband. In this case, the spectrum information B(j) of the j-th subband is expressed by following equation 3.

$$B ( j ) = {\sum }_{k = BL ( j )}^{BH ( j )} S 1 {( k )}^{2} \qquad ( Equation 3 )$$

In this equation, BL(j) is the lowest frequency in the j-th subband and BH(j) is the highest frequency in the j-th subband. The spectrum amplitude information of each subband in the higher band of the input spectrum calculated as above is regarded as gain information of the higher band of the input spectrum.

Gain coding section 117 has a gain codebook for encoding the gain information of the higher band FL≦k<FH of the input spectrum S1(k) (0≦k<FH). The gain codebook stores a plurality of gain vectors where the number of elements is J, and gain coding section 117 searches for the gain vector that is most similar to the gain information calculated using equation 3, and outputs the index associated with this gain vector to multiplexing section 118.

Multiplexing section 118 multiplexes the optimal pitch coefficient received from searching section 116 and the gain vector index received from gain coding section 117, and outputs the result to multiplexing section 106 as second layer encoded data.

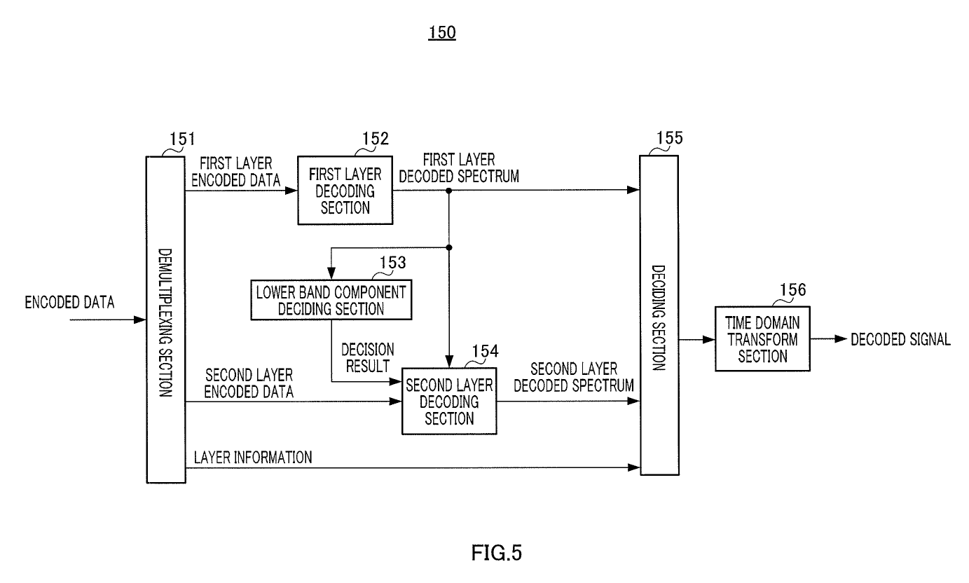

FIG. 5 is a block diagram showing main components of speech decoding apparatus 150 according to the present embodiment. This speech decoding apparatus 150 decodes the encoded data generated in speech coding apparatus 100 shown in FIG. 3. The sections of speech decoding apparatus 150 perform the following operations.

Demultiplexing section 151 demultiplexes the encoded data superimposed over a bit stream transmitted from the radio transmitting apparatus into the first layer encoded data and the second layer encoded data. Further, demultiplexing section 151 outputs the first layer encoded data to first layer decoding section 152 and the second layer encoded data to second layer decoding section 154. Further, demultiplexing section 151 demultiplexes, from the bit stream, layer information showing encoded data of which layer is included, and outputs the layer information to deciding section 155.

First layer decoding section 152 generates the first layer decoded spectrum S2(k) (0≦k<FL) by performing the decoding process of the first layer encoded data received from demultiplexing section 151, and outputs the result to lower band component deciding section 153, second layer decoding section 154 and deciding section 155.

Lower band component deciding section 153 decides whether or not there are lower band components (0≦k<FL) in the first layer decoded spectrum S2(k) (0≦k<FL) received from first layer decoding section 152, and outputs the decision result to second layer decoding section 154. Here, if it is decided that there are the lower band components, the decision result is “1,” and, if it is decided that there are no lower band components, the decision result is “0.” The decision method includes comparing the energy of the lower band components and a predetermined threshold, deciding that there are the lower band components if the lower band component energy is equal to or higher than the threshold, and deciding that there are no lower band components if the lower band component energy is lower than the threshold.

Second layer decoding section 154 generates a second layer decoded spectrum using the second layer encoded data received from demultiplexing section 151, the decision result received from lower band component deciding section 153 and the first layer decoded spectrum S2(k) received from first layer decoding section 152, and outputs the result to deciding section 155. Further, second layer decoding section 154 will be described later in detail.

Deciding section 155 decides, based on the layer information outputted from demultiplexing section 151, whether or not the encoded data superimposed over the bit stream includes second layer encoded data. Here, although a radio transmitting apparatus having speech coding apparatus 100 transmits a bit stream including both first layer encoded data and second layer encoded data, the second layer encoded data may be discarded somewhere in the transmission path. Therefore, deciding section 155 decides, based on the layer information, whether or not the bit stream includes second layer encoded data. Further, if the bit stream does not include second layer encoded data, second layer decoding section 154 cannot generate the second layer decoded spectrum, and, consequently, deciding section 155 outputs the first layer decoded spectrum to time domain transform section 156. However, in this case, to match the bandwidth of the first layer decoded spectrum with the bandwidth of the decoded spectrum in a case where second layer encoded data is included, deciding section 155 extends the bandwidth of the first layer decoded spectrum to FH, and outputs the spectrum of the band between FL and FH as “0.” On the other hand, when the bit stream includes both the first layer encoded data and the second layer encoded data, deciding section 155 outputs the second layer decoded spectrum to time domain transform section 156.

Time domain transform section 156 generates and outputs a decoded signal by transforming the decoded spectrum outputted from deciding section 154 into a time domain signal.

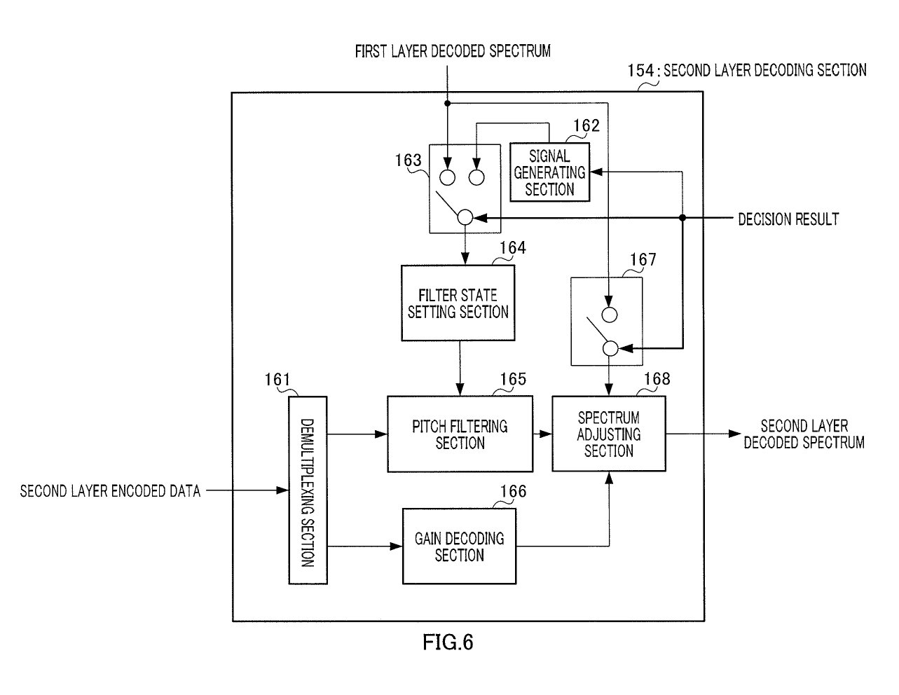

FIG. 6 is a block diagram showing main components inside second layer decoding section 154 described above.

Demultiplexing section 161 demultiplexes the second layer encoded data outputted from demultiplexing section 151 into optimal pitch coefficient T′, which is information about filtering, and the gain vector index, which is information about gain. Further, demultiplexing section 161 outputs the information about filtering to pitch filtering section 165 and the information about gain to gain decoding section 166.

Signal generating section 162 employs a configuration corresponding to the configuration of signal generating section 111 inside speech coding apparatus 100. If the decision result received from lower band component deciding section 104 is “0,” signal generating section 162 generates a random number signal, a signal clipping a random number or a predetermined signal designed in advance by learning, and outputs the result to switch 163.

Switch 163 outputs the first layer decoded spectrum S2(k) (0<k<FL) to filter state setting section 164 if the decision result received from lower band component deciding section 153 is “1,” while outputting the predetermined signal received from signal generating section 162 to filter state setting section 164 if the decision result is “0.”

Filter state setting section 164 employs a configuration corresponding to the configuration of filter state setting section 113 inside speech coding apparatus. Filter state setting section 164 sets the predetermined signal or first layer decoded spectrum S2(k) (0≦k<FL) received from switch 163, as the filter state that is used in pitch filtering section 165. Here, the spectrum over the entire frequency band 0≦k<FH will be referred to as “S(k)” for ease of explanation, and the first layer decoded spectrum S2(k) 0≦k<FL is accommodated as the internal state of the filter (i.e. filter state).

Pitch filtering section 165 has a configuration corresponding to the configuration of pitch filtering section 115 inside speech coding apparatus 100. Pitch filtering section 165 performs the filtering shown in above-described equation 2 with respect to the first layer decoded spectrum S2(k), based on the pitch coefficient T′ outputted from demultiplexing section 161 and the filter state set in filter state setting section 164. Further, pitch filtering section 165 calculates the estimated spectrum S1′(k) (FL≦k<FH) for the highband of the input spectrum S1(k) (0≦k<FH). Pitch filtering section 165 also uses the filter function shown in above equation 1 and outputs the whole band spectrum S(k) including the calculated estimated spectrum S1′(k) (FL≦k<FH), to spectrum adjusting section 168.

Gain decoding section 166 has the same gain codebook as in gain coding section 117 of speech coding apparatus 100, and decodes the gain vector index received from demultiplexing section 161 and calculates decoded gain information B_{q}(j) representing the quantization value of the gain information B(j). To be more specific, gain decoding section 166 selects the gain vector associated with the gain vector index received from demultiplexing section 161 from the gain codebook, and outputs the selected gain vector to spectrum adjusting section 168 as the decoded gain information B_{q}(j).

Switch 167 outputs the first layer decoded spectrum S2(k) (0≦k<FL) received from first layer decoding section 152, to spectrum adjusting section 168 only when the decision result received from lower band component deciding section 153 is “1.”

Spectrum adjusting section 168 multiplies the estimated spectrum S1′(k) (FL≦k<FH) received from pitch filtering section 165 by the decoded gain information B_{q}(j) of each subband received from gain decoding section 166, according to following equation 4. By this means, spectrum adjusting section 168 adjusts the spectrum shape of the frequency band FL≦k<FH of the estimated spectrum S1′(k) and generates decoded spectrum S(k) (FL≦k<FH). Further, spectrum adjusting section 168 outputs the generated decoded spectrum S(k) to deciding section 155.

$$S 3 ( k ) = \frac{S {1}^{′} ( k )}{\sqrt{{\sum }_{k = BL ( j )}^{BH ( j )} S {1}^{′} {( k )}^{2}}} \cdot {B}_{q} ( j ) ( \begin{matrix}BL ( j ) \leq k \leq BH ( j ) , \\ for all j\end{matrix} ) \qquad ( Equation 4 )$$

Thus, the higher band FL≦k<FH of the decoded spectrum S(k) (0≦k<FH) is formed with the adjusted estimated spectrum S1′(k) (FL≦k<FH). However, as described in the operations of pitch filtering section 115 inside speech coding apparatus 100, if the decision result received from lower band component deciding section 153 to second layer decoding section 154 is “0,” the lower band 0≦k<FL of the decoded spectrum S(k) (0≦k<FH) is not formed with the first decoded layer spectrum S2(k) (0≦k<FL) but instead formed with the predetermined signal generated in signal generating section 162. Although the predetermined signal is required for the decoding process of the higher band components in filter state setting section 164, pitch filtering section 165 and gain decoding section 166, if this predetermined signal is included in a decoded signal and outputted as is, noise is produced and the sound quality of the decoded signal degrades. Therefore, if the decision result inputted from lower band component deciding section 153 to second layer decoding section 154 is “0,” spectrum adjusting section 168 assigns the first decoded layer spectrum S2(k) (0≦k<FL) received from first layer decoding section 152, to the lower band of the whole band spectrum (0≦k<FH). The present embodiment assigns first layer decoded spectrum S2(k) to the lower band 0≦k<FL of decoded spectrum S(k) based on the decision result if the decision result shows that there are no lower band components in the input signal.

Thus, speech decoding apparatus 150 can decode encoded data generated in speech coding apparatus 100.

As described above, the present embodiment decides whether or not there are lower band components in a first layer decoded signal (or first layer decoded spectrum), and, if there are lower band components, allocates predetermined components in the lower band, estimates the higher band components using the predetermined signal allocated in the lower band in a second layer coding section, and adjusts the gain. By this means, it is possible to efficiently encode the higher band of a spectrum utilizing the lower band of the spectrum, so that, even if there are no lower band components in part of the speech signal, it is possible to alleviate the sound quality degradation of the decoded signal.

Further, according to the present embodiment, problems to be solved by the present invention can be solved without changing the configuration for the second coding process significantly, so that it is possible to limit the increase of hardware (or software) to implement the present invention.

Further, although an example case has been described with the present embodiment where the energy of lower band components and a predetermined threshold are compared as a decision method in lower band component deciding sections 104 and 153, it is equally possible to change this threshold over time. For example, by combining the present embodiment with known active speech or inactive speech determination techniques, if it is decided that a speech signal is inactive, the lower band component energy at that time is used to update the threshold. By this means, a reliable threshold is calculated, so that it is possible to decide more accurately whether or not there are lower band components.

Although an example case has been described with the present embodiment where the first decoded layer spectrum S2(k) (0≦k<FL) is assigned to the lower band of the whole band spectrum S(k) (0≦k<FH), it is equally possible to assign zero values instead of the first decoded layer spectrum S2(k) (0≦k<FL).

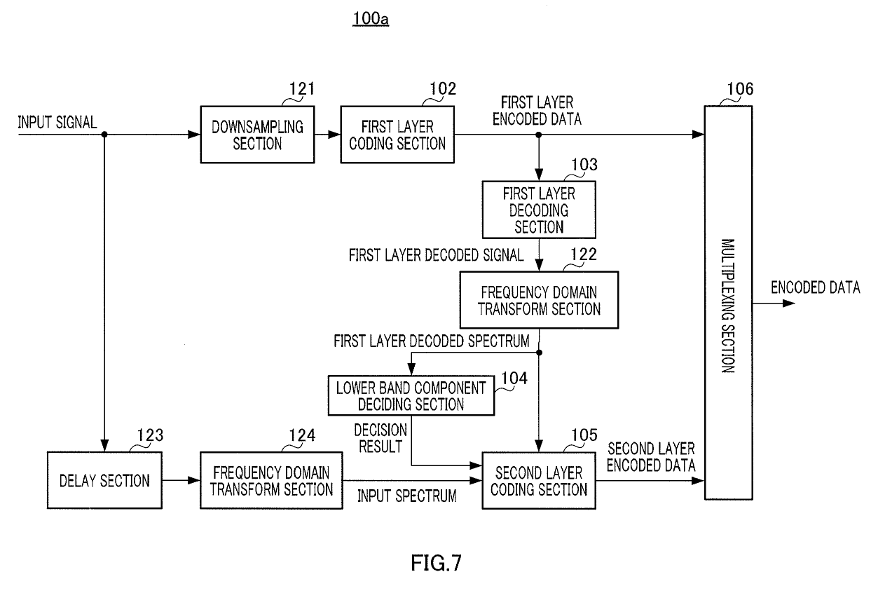

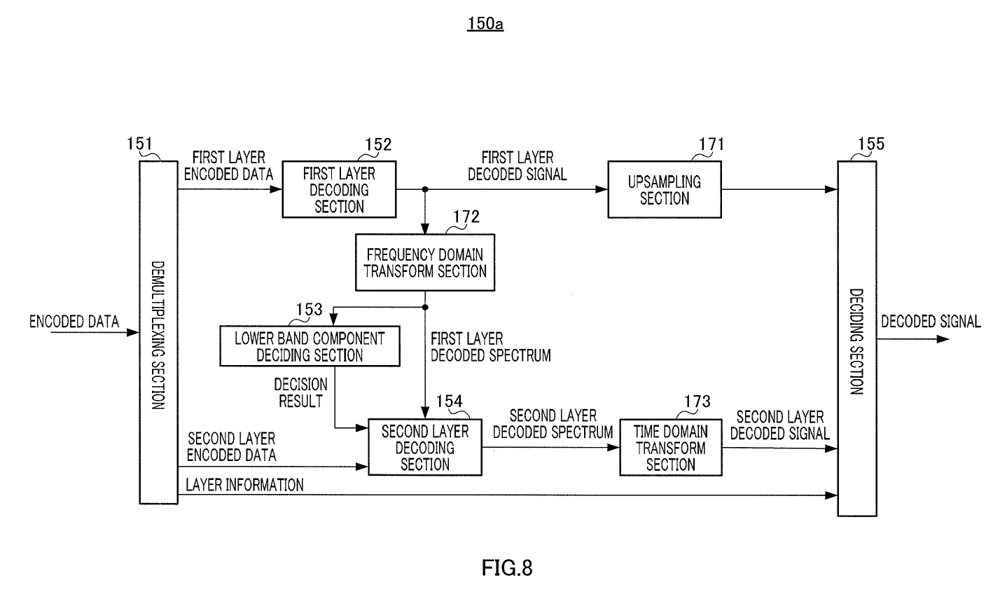

Further, in the present embodiment, it is equally possible to employ the configuration shown below. FIG. 7 is a block diagram showing another configuration 100a of speech coding apparatus 100. Further, FIG. 8 is a block diagram showing main components of speech decoding apparatus 150a supporting speech coding apparatus 100. The same configurations as in speech coding apparatus 100 and speech decoding apparatus 150 will be assigned the same reference numerals and their explanations will be basically omitted.

In FIG. 7, downsampling section 121 performs downsampling of an input speech signal in the time domain and converts its sampling rate to a desired sampling rate. First layer coding section 102 encodes the time domain signal after the downsampling using CELP coding, and generates first layer encoded data. First layer decoding section 103 decodes the first layer encoded data and generates a first layer decoded signal. Frequency domain transform section 122 performs a frequency analysis of the first layer decoded signal and generates the first layer decoded spectrum. Lower band component deciding section 104 decides whether or not there are lower band components in the first layer decoded spectrum, and outputs the decision result. Delay section 123 gives a delay matching the delay caused in downsampling section 121, first layer coding section 102 and first layer decoding section 103, to the input speech signal. Frequency domain transform section 124 performs a frequency analysis of the delayed input speech signal and generates an input spectrum. Second layer coding section 105 generates second layer encoded data using the decision result, the first layer decoded spectrum and the input spectrum. Multiplexing section 106 multiplexes the first layer encoded data and the second layer encoded data, and outputs the resulting encoded data.

Further, in FIG. 8, first layer decoding section 152 decodes the first layer encoded data outputted from demultiplexing section 151 and acquires the first layer decoded signal. Upsampling section 171 changes the sampling rate of the first layer decoded signal into the same sampling rate as the input signal. Frequency domain transform section 172 performs a frequency analysis of the first layer decoded signal and generates the first layer decoded spectrum. Lower band component deciding section 153 decides whether or not there are lower band components in the first layer decoded spectrum, and outputs the decision result. Second layer decoding section 154 decodes the second layer encoded data outputted from demultiplexing section 151 using the decision result and the first layer decoded spectrum, and acquires the second layer decoded spectrum. Time domain transform section 173 transforms the second layer decoded spectrum into a time domain signal and acquires a second layer decoded signal. Deciding section 155 outputs one of the first layer decoded signal and the second layer decoded signal or both signals, based on the layer information outputted from demultiplexing section 151.

Thus, in the above variation, first layer coding section 102 performs a coding process in the time domain. First layer coding section 102 uses CELP coding for enabling coding of a speech signal with high quality at a low bit rate. Therefore, first layer coding section 102 uses CELP coding, so that it is possible to reduce the overall bit rate of the scalable coding apparatus and realize sound quality improvement. Further, CELP coding can alleviate the inherent delay (i.e. algorithm delay) compared to transform coding, so that it is possible to reduce the overall inherent delay of the scalable coding apparatus and realize a speech coding process and decoding process suitable for mutual communication.

### Embodiment 2

Embodiment 2 of the present invention differs from Embodiment 1 of the present invention in changing a gain codebook that is used upon second layer coding, based on the decision result as to whether or not there are lower band components in the first layer decoded signal. To show the difference, second layer coding section 205 changing and using the gain codebook according to the present embodiment will be assigned the different reference numeral from second layer coding section 105 shown in Embodiment 1.

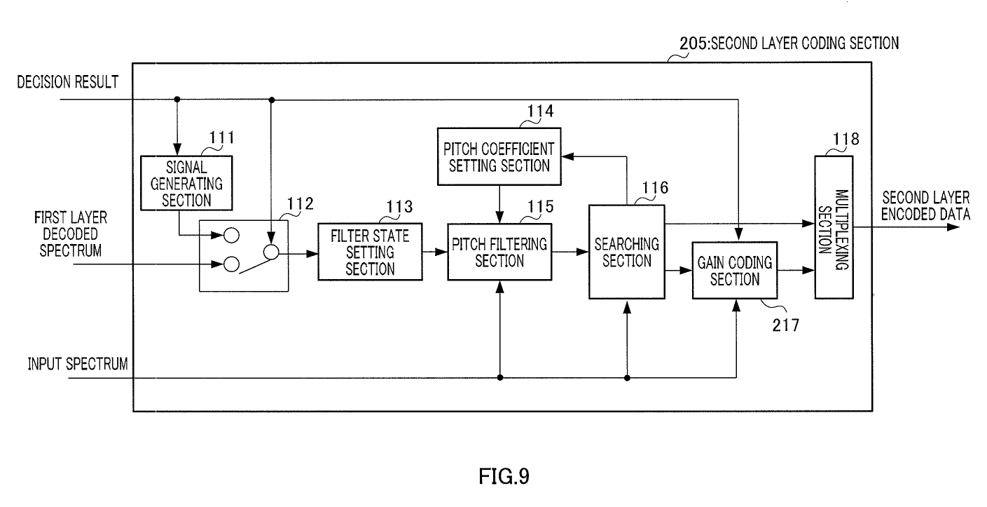

FIG. 9 is a block diagram showing main components of second layer coding section 205. In second layer coding section 205, the same components as in second layer coding section 105 (see FIG. 4) shown in Embodiment 1 will be assigned the same reference numerals and their explanations will be omitted.

In second layer coding section 205, gain coding section 217 differs from gain coding section 117 of second layer coding section 105 shown in Embodiment 1 in further receiving the decision result from lower band component deciding section 104, and, to show these differences, is assigned the different reference numeral.

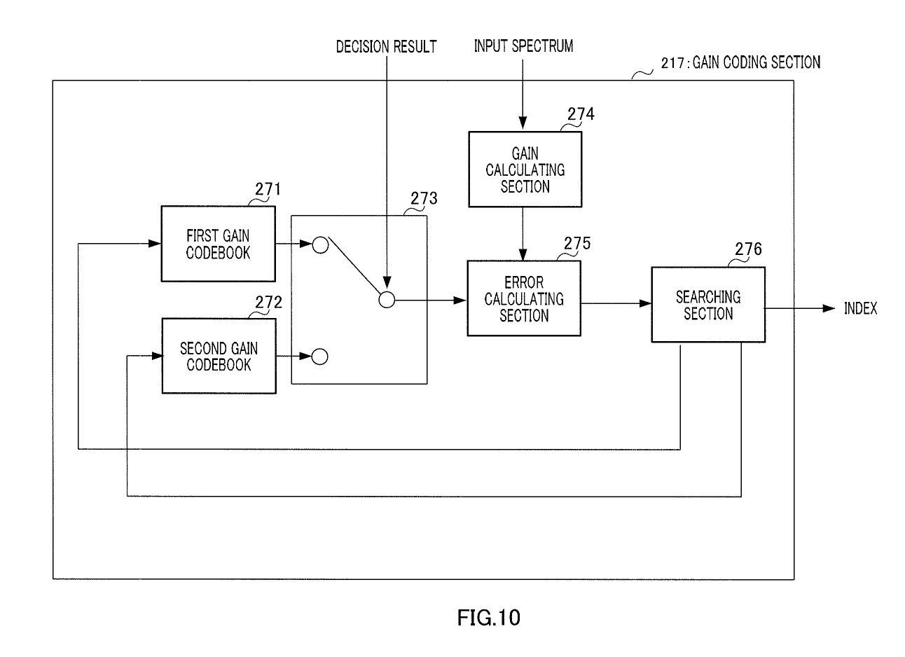

FIG. 10 is a block diagram showing main components inside gain coding section 217.

First gain codebook 271 is the gain codebook designed using learning data such as speech signals, and is comprised of a plurality of gain vectors suitable for general input signals. First gain codebook 271 outputs a gain vector associated with an index received from searching section 276 and outputs the gain vector to switch 273.

Second gain codebook 272 is the gain codebook having a plurality of vectors in which a certain element or a limited number of elements have much higher values than the other elements. Here, for example, the difference between a certain element and the other elements, or the difference between each of a limited number of elements and the other elements is compared with a predetermined threshold, and, if the difference is greater than the predetermined threshold, it is possible to decide that the certain element or the limited number of elements are much higher than the other elements. Second gain codebook 272 outputs a gain vector associated with the index received from searching section 276.

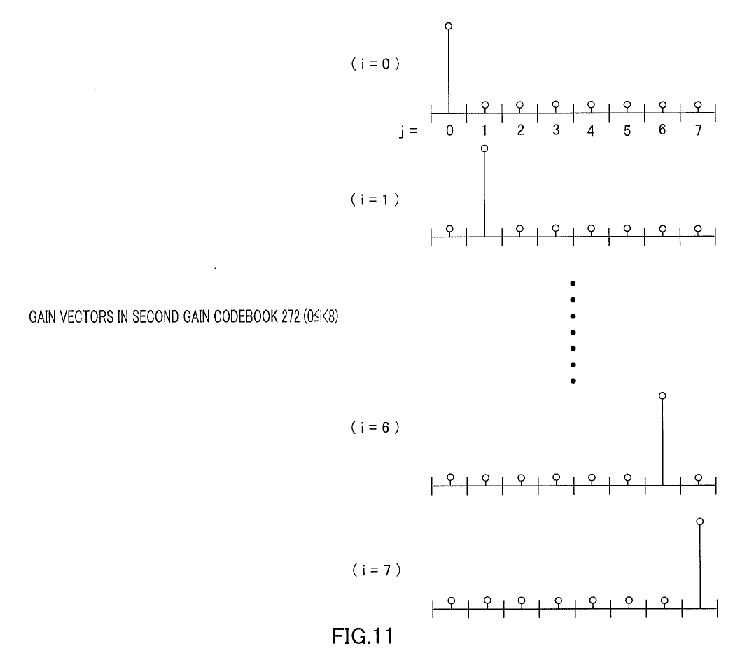

FIG. 11 illustrates gain vectors included in second gain codebook 272. This figure shows as case where the vector dimension J is eight. As shown in this figure, a certain element of a vector has a much higher value than the other elements. By using such second gain codebook 272, in a case where a sine wave (line spectrum) or a waveform comprised of a limited number of sine waves is inputted in the higher band components, it is possible to select a gain vector in which the gain in the subband including the sine wave is higher and the gain in the other subbands is smaller. Therefore, it is possible to encode the sine wave inputted in the speech coding apparatus more accurately.

Here, referring back to FIG. 10, switch 273 outputs the gain vector received from first gain codebook 271 to error calculating section 275 if the decision result received from lower band component deciding section is “1,” while outputting the gain vector received from second gain codebook 272 to error calculating section 275 if the decision result is “0.”

Based on the higher band FL≦k<FH of the input spectrum S1(k) (0≦k<FH) outputted from frequency domain transform section 101, gain calculating section 274 calculates gain information B(j) of the input spectrum S1(k) according to above-noted equation 3. Gain calculating section 274 outputs the calculated gain information B(j) to error calculating section 275.

Error calculating section 275 calculates the error E (i) between the gain information B(j) received from gain calculating section 274 and the gain vector received from switch 273, according to following equation 5. Here, G(i,j) represents the gain vector received from switch 273, and index “i” represents the order of the gain vector G(i,j) in first gain codebook 271 or second gain codebook 272.

$$E ( i ) = {\sum }_{j = 0}^{J - 1} {( B ( j ) - G ( i , j ) )}^{2} \qquad ( Equation 5 )$$

Error calculating section 275 outputs the calculated error E(i) to searching section 276.

Searching section 276 sequentially changes and outputs indexes indicating the gain vectors to first gain codebook 271 or second gain codebook 272. Further, the processes in first gain codebook 271, second gain codebook 272, switch 273, error calculating section 275 and searching section 276 form a closed loop. Here, the gain vector in which the error E(i) received from error calculating section 275 is minimum, is decided. Further, searching section 276 outputs an index indicating the decided gain vector to multiplexing section 118.

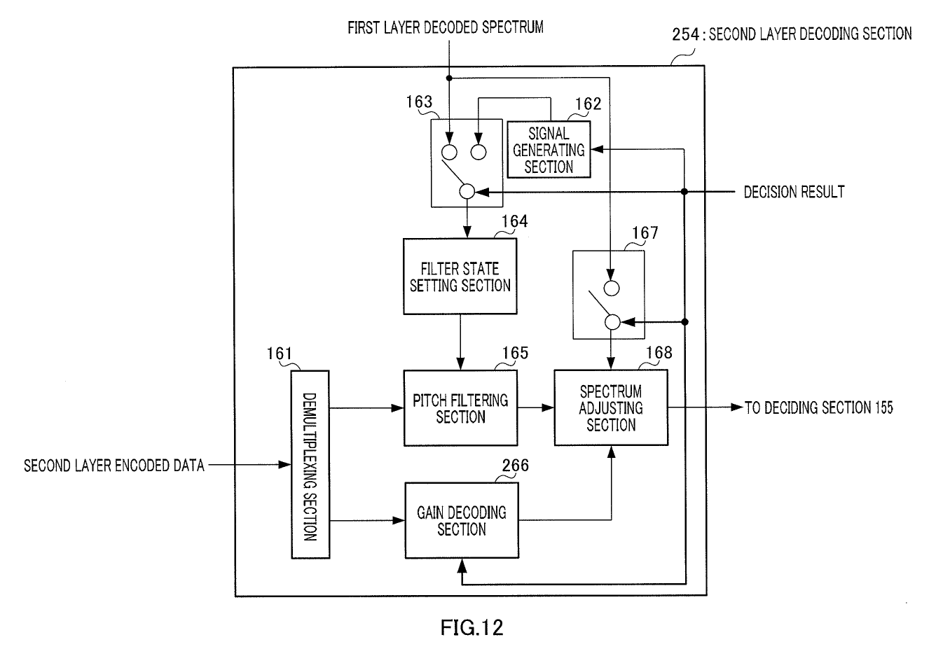

FIG. 12 is a block diagram showing main components inside second layer decoding section 254 included in the speech decoding apparatus according to the present embodiment. In second layer decoding section 254, the same components as in second layer decoding section 154 shown in Embodiment 1 will be assigned the same reference numerals and their explanations will be omitted.

In second layer decoding section 254, gain decoding section 266 differs from gain decoding section 166 of second layer decoding section 154 shown in Embodiment 1 in further receiving the decision result from lower band component deciding section 153, and, to show these differences, is assigned the different reference numeral.

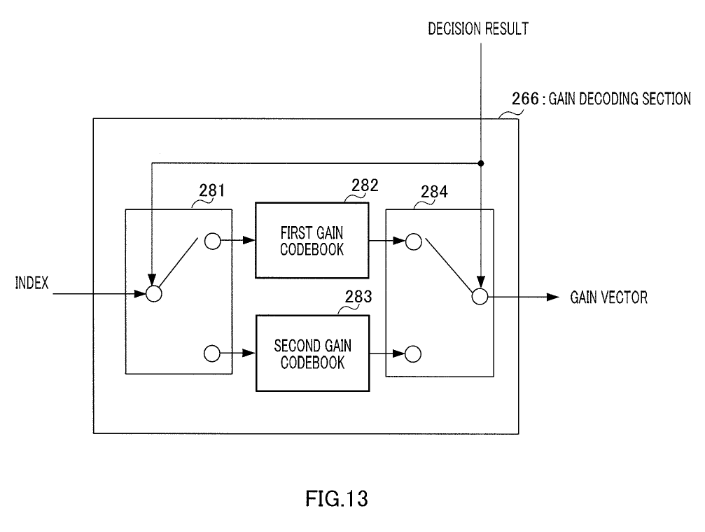

FIG. 13 is a block diagram showing main components inside gain decoding section 266.

Switch 281 outputs a gain vector index received from demultiplexing section 161, to first gain codebook 282 if the decision result received from lower band component deciding section 153 is “1,” while outputting the gain vector index received from demultiplexing section 161, to second gain codebook 283 if the decision result is “0.”

First gain codebook 282 is the same gain codebook as first gain codebook 271 included in gain coding section 217 according to the present embodiment, and outputs a gain vector associated with the index received from switch 281, to switch 284.

Second gain codebook 283 is the same gain codebook as second gain codebook 272 included in gain coding section 217 according to the present embodiment, and outputs a gain vector associated with the index received from switch 281, to switch 284.

Switch 284 outputs the gain vector received from first gain codebook 282, to spectrum adjusting section 168 if the decision result received from lower band component deciding section 153 is “1,” while outputting the gain vector received from second gain codebook 283, to spectrum adjusting section 168 if the decision result is “0.”

As described above, the present embodiment provides a plurality of gain codebooks that are used upon second layer coding, and changes a gain codebook to be used according to the decision result as to whether or not there are lower band components in the first layer decoded signal. By encoding an input signal not containing lower band components and containing higher band components alone, using a different gain codebook from the gain codebook suitable for general speech coding, it is possible to efficiently encode the higher band of a spectrum utilizing the lower band of the spectrum. Therefore, if there are no lower band components in part of a speech signal, it is possible to further alleviate speech degradation of the decoded signal.

### Embodiment 3

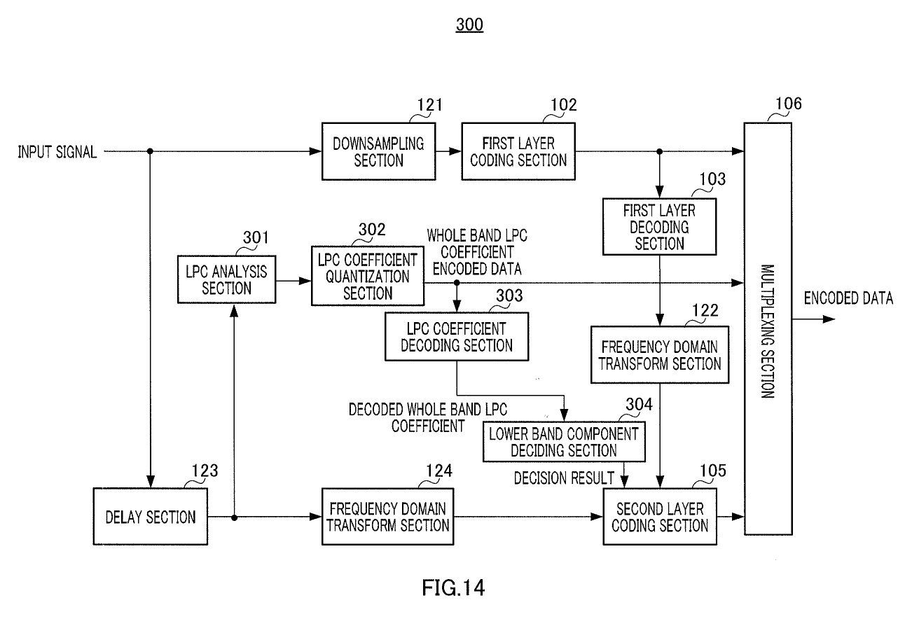

FIG. 14 is a block diagram showing main components of speech coding apparatus 300 according to Embodiment 3 of the present invention. In speech coding apparatus 300, the same components as in speech coding apparatus employing another configuration 100a (see FIG. 7) shown in Embodiment 1 will be assigned the same reference numerals and their explanations will be omitted.

Speech coding apparatus 300 differs from speech coding apparatus 100a in further having LPC (Linear Prediction Coefficient) analysis section 391, LPC coefficient quantization section 302 and LPC coefficient decoding section 303. Further, lower band component deciding section 304 of speech coding apparatus 300 differs from lower band component deciding section 104 of speech coding apparatus 100a in part of the processes, and, to show these differences, is assigned the different reference numeral.

LPC analysis section 301 performs an LPC analysis of a delayed input signal received from delay section 123, and outputs the resulting LPC coefficients to LPC coefficient quantization section 302. These resulting LPC coefficients in LPC analysis section 301 will be referred to as “whole band LPC coefficients.”

LPC coefficient quantization section 302 converts the whole band LPC coefficients received from LPC analysis section 301 into parameters suitable for quantization, such as LSP (Line Spectral Pair) and LSF (Line Spectral Frequencies), and quantizes the parameters resulting from this conversion. Further, LPC coefficient quantization section 302 outputs the whole band LPC coefficient encoded data resulting from the quantization, to multiplexing section 106 and LPC coefficient decoding section 303.

LPC coefficient decoding section 303 calculates the decoded whole band LPC coefficients by decoding the parameters such as LSP and LSF using the whole band LPC coefficient encoded data received from LPC coefficient quantization section 302, and by converting the decoded parameters such as LSP and LSF into LPC coefficients. Further, LPC coefficient decoding section 303 outputs the calculated decoded whole band LPC coefficients to lower band component deciding section 304.

Lower band component deciding section 304 calculates a spectral envelope using the decoded whole band LPC coefficients received from LPC coefficient decoding section 303, and calculates the energy ratio of the calculated spectral envelope between the higher band and the lower band. Lower band component deciding section 304 outputs “1” to second layer coding section 105 as a decision result showing that there are lower band components if the energy ratio of the spectral envelope between the lower band and the higher band is equal to or higher than a threshold, while outputting “0” to second layer coding section 105 as a decision result showing that there are no lower band components if the energy ratio of the spectral envelope between the lower band and the higher band is lower than the predetermined threshold.

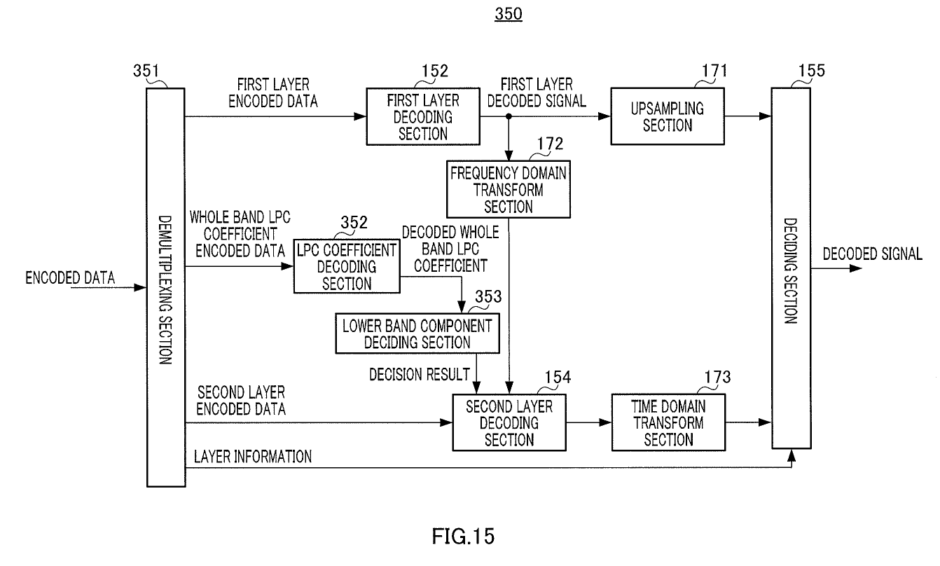

FIG. 15 is a block diagram showing main components of speech decoding apparatus 350 according to the present embodiment. Further, speech decoding apparatus 350 has the same basic configuration as speech decoding apparatus 150 employing another configuration 150a (see FIG. 8) shown in Embodiment 1, and therefore the same components will be assigned the same reference numerals and their explanations will be omitted.

Speech decoding apparatus 350 differs from speech decoding apparatus 150a in further having LPC coefficient decoding section 352. Further, demultiplexing section 351 and lower band components deciding section 353 of speech decoding apparatus 350 differ from demultiplexing section 151 and lower band component deciding section 153 of speech decoding apparatus 150a in part of the processes, and, to show these differences, are assigned the different reference numerals.

Demultiplexing section 351 differs from demultiplexing section 151 of speech decoding apparatus 150 in further demultiplexing encoded data superimposed over a bit stream transmitted from the radio transmitting apparatus into whole band LPC coefficient encoded data.

LPC coefficient decoding section 352 calculates decoded whole band LPC coefficients by decoding the parameters such as LSP and LSF using the whole band LPC coefficient encoded data received from demultiplexing section 351, and by converting the decoded parameters such as LSP and LSF into LPC coefficients. Further, LPC coefficient decoding section 352 outputs the calculated decoded whole band LPC coefficients to lower band component deciding section 353.

Lower band component deciding section 353 calculates a spectral envelope using the decoded whole band LPC coefficients received from LPC coefficient decoding section 352, and calculates the energy ratio of the calculated spectral envelope between the higher band and the lower band. Lower band component deciding section 353 outputs “1” to second layer decoding section 154 as a decision result showing that there are lower band components if the energy ratio of the spectral envelope between the lower band and the higher band is equal to or higher than a threshold, while outputting “0” to second layer coding section 105 as a decision result showing that there are no lower band components if the energy ratio of the spectral envelope between the lower band and the higher band is lower than the predetermined threshold.

As described above, according to the present embodiment, a spectral envelope is calculated based on LPC coefficients, and whether or not there are lower band components is decided using this spectral envelope, so that it is possible to perform determination not depending on the absolute energy of signals. Further, upon efficiently encoding the higher band of a spectrum utilizing the lower band of the spectrum, if there are no lower band components in part of the speech signal, it is possible to further alleviate speech degradation of the decoded signal.

### Embodiment 4

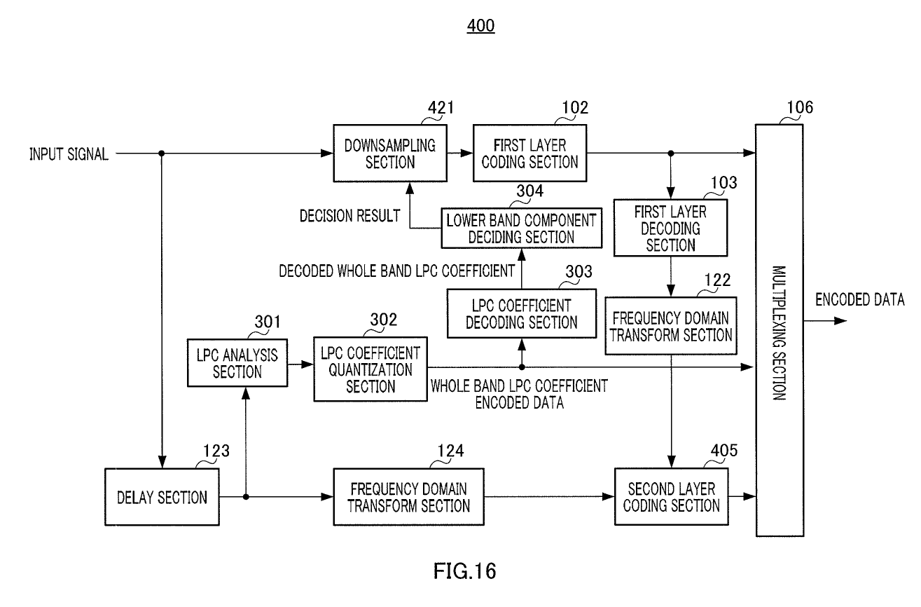

FIG. 16 is a block diagram showing main components of speech coding apparatus 400 according to Embodiment 4 of the present invention. In speech coding apparatus 400, the same components as in speech coding apparatus 300 shown in Embodiment 3 will be assigned the same reference numerals and their explanations, will be omitted.

Speech coding apparatus 400 differs from speech coding apparatus 300 in outputting the decision result of lower band component deciding section 304 not to second layer coding section 105 but to downsampling section 421. Further, downsampling section 421 and second layer coding section 405 of speech coding apparatus 400 different from downsampling section 121 and second layer coding section 105 of speech coding apparatus 300 in part of the processes, and, to show these differences, are assigned the different reference numerals.

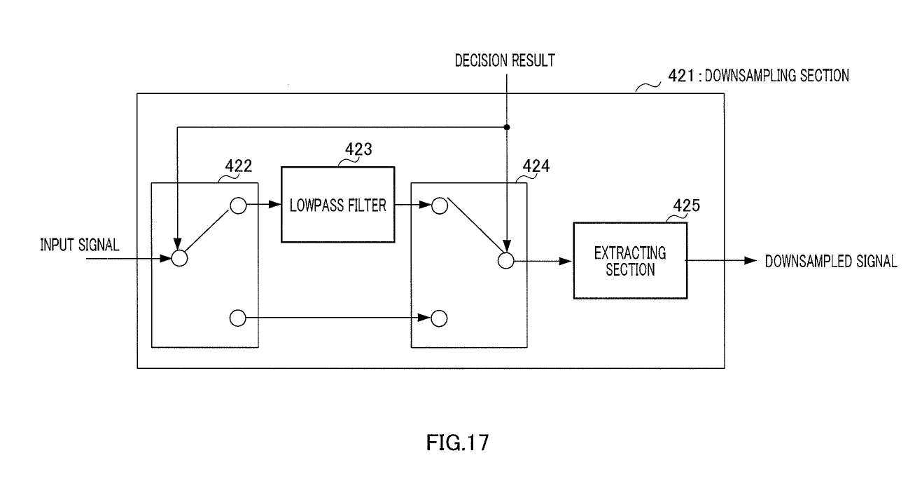

FIG. 17 is a block diagram showing main components inside downsampling section 421.

Switch 422 outputs an input speech signal to low-pass filter 423 if the decision result received from lower band component deciding section 304 is “1,” while directly outputting the input speech signal to switch 424 if the decision result is “0.”

Lowpass filter 423 blocks the higher band between FL and FH of the speech signal received from switch 422, and passes and outputs only the lower band between 0 and FL of the speech signal to switch 424. The sampling rate of the output signal in lowpass filter 423 is the same as the sampling rate of the speech signal inputted in switch 422.

Switch 424 outputs the speech signal received from lowpass filter 423, to extracting section 425 if the decision result received from lower band component deciding section 304 is “1,” while directly outputting the speech signal received from switch 422, to extracting section 425 if the decision result is “0.”

Extracting section 425 reduces the sampling rate by extracting the speech signal or the lower band components of the speech signal received from switch 424, and outputs the result to first layer coding section 102. For example, when the sampling rate of one of the speech signals received from switch 424 is 16 kHz, extracting section 425 reduces the sampling rate to 8 kHz by selecting every other sample, and outputs the result.

Thus, if the decision result received from lower band component deciding section 304 is “0,” that is, if there are no lower band components in the input speech signal, downsampling section 421 does not perform a lowpass filtering process of the speech signal and yet performs a extracting process directly. By this means, aliasing distortion is observed in the lower band of the speech signal, and components that are provided only in the higher band are folded in the lower band as a mirror image.

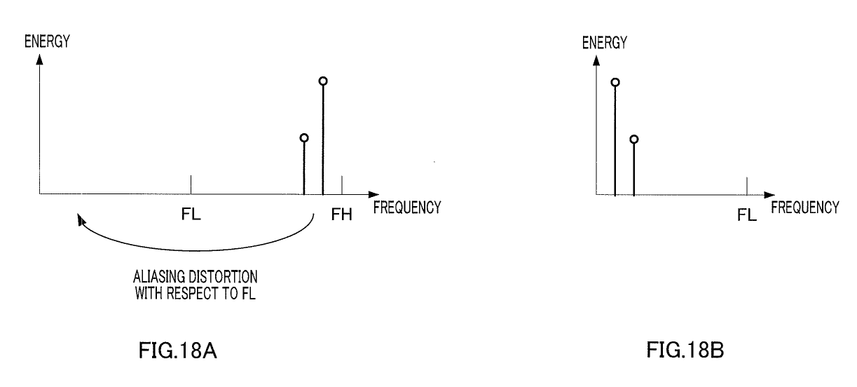

FIG. 18 illustrates a state of spectral change where a lowpass filtering process is not performed and a extracting process is directly performed in downsampling section 421. Here, a case will be explained where the sampling rate of the input signal is 16 kHz and the sampling rate of the signal resulting from extracting is 8 kHz. In this case, extracting section 425 selects every other sample and outputs the results. Further, in this figure, the horizontal axis represents frequencies, FL is 4 kHz, FH is 8 kHz, and the vertical axis represents spectrum amplitude values.

FIG. 18A illustrates the spectrum of a signal inputted in downsampling section 421. In a case where a lowpass filtering process is not performed with respect to the input signal shown in FIG. 18A and a extracting process is performed every other sample, aliasing distortion appears symmetrically with respect to FL as shown in FIG. 18B. By this extracting process, the sampling rate becomes 8 kHz, and, consequently, the signal band becomes between 0 and FL. Therefore, the maximum frequency on the horizontal axis in FIG. 18 is FL. In the present embodiment, the signal including lower band components as shown in FIG. 18B is used for the signal processing after the downsampling. That is, if there are no lower band components in an input signal, a predetermined signal is not allocated in the lower band, but instead the mirror image of the higher band components produced in the lower band, is used to encode the higher band. Therefore, features of the spectrum shape of higher band components (such as high peak levels and high noise levels) are folded in lower band components, so that it is possible to encode the higher band components more accurately.

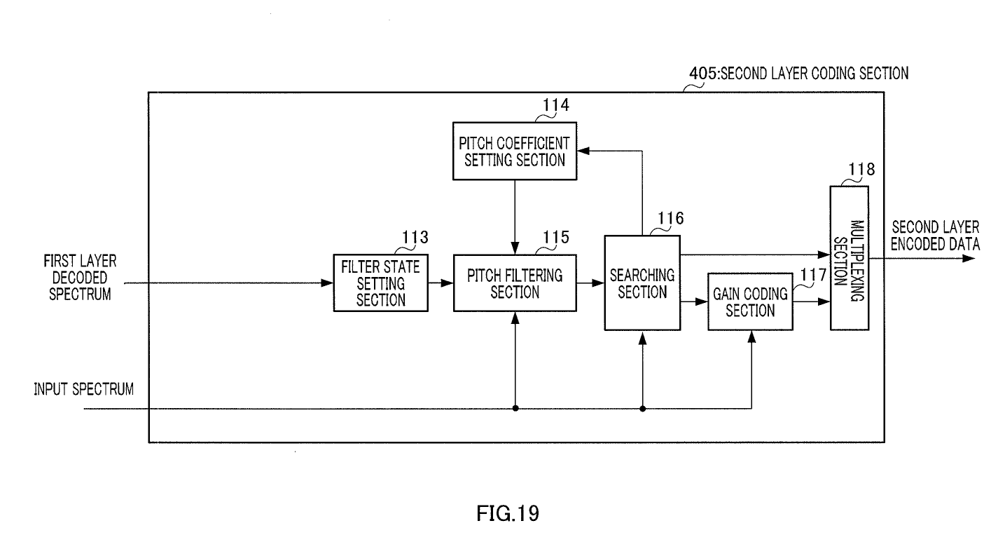

FIG. 19 is a block diagram showing main components of second layer coding section 405 according to the present embodiment. In second layer coding section 405, the same components as in second layer coding section 105 (see FIG. 4) shown in Embodiment 1 will be assigned the same reference numerals and their explanations will be omitted.

Second layer coding section 405 differs from second layer coding section 105 shown in Embodiment 1 in not requiring signal generating section 111 and switch 112. This is because, if an input speech signal does not include lower band components, the present embodiment does not allocate a predetermined signal in the lower band, and instead performs a extracting process directly with respect to the input speech signal, without performing a lowpass filtering process, so that, using the signal after the extracting process, the first layer coding process and second layer coding process are performed. Therefore, second layer coding section 405 needs not generate a predetermined signal based on the decision result in the lower band component deciding section.

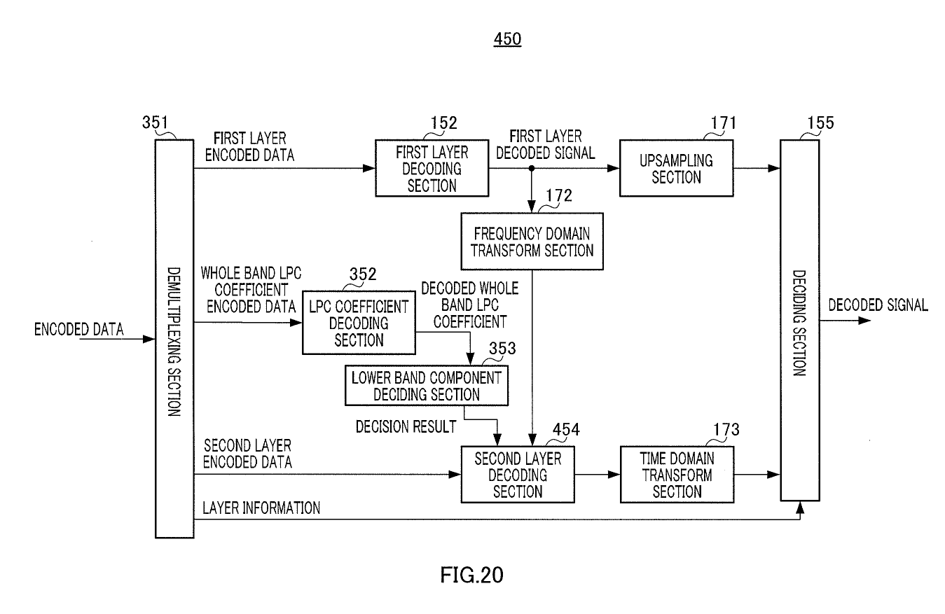

FIG. 20 is a block diagram showing main components of speech decoding apparatus 450 according to the present embodiment. In speech decoding apparatus 450, the same components as in speech decoding apparatus 350 (see FIG. 15) according to Embodiment 3 of the present invention will be assigned the same reference numerals and their explanations will be omitted. Second layer decoding section 454 of speech decoding apparatus 450 differs from second layer decoding section 154 of speech decoding apparatus 350 in part of the processes, and, to show these differences, is assigned the different reference numeral.

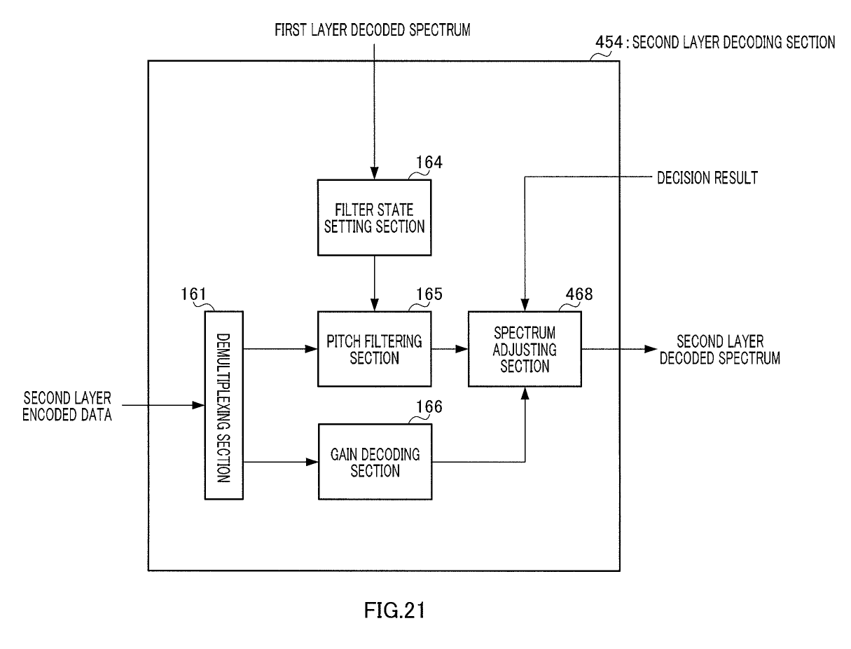

FIG. 21 is a block diagram showing main components of second layer decoding section 454 included in the speech decoding apparatus according to the present embodiment. In second layer decoding section 454, the same components as in second layer decoding section 154 shown in FIG. 6 will be assigned the same reference numerals and their explanations will be omitted.

Second layer decoding section 454 differs from second layer decoding section 154 shown in Embodiment 1, in not requiring signal generating section 162, switch 163 and switch 167. This is because, if lower band components are not included in a speech signal that is inputted in speech coding apparatus 400 according to the present embodiment, the present embodiment does not allocate a predetermined signal in the lower band, and, instead, performs a extracting process directly with respect to the input speech signal, without performing a lowpass filtering process, so that, using the signal after the extracting process, first layer coding processing and second layer coding processing are performed. Therefore, even second layer decoding section 454 needs not generate and decode a predetermined signal based on the decision result in the lower band component deciding section.

Further, spectrum adjusting section 468 of second layer decoding section 454 differs from spectrum adjusting section 168 of second layer decoding section 154 in assigning zero values instead of the first layer spectrum S2(k) (0≦k<FL) to the lower band of the whole band spectrum S(k) (0≦k<FH) if the decision result received from lower band component deciding section 353 is “0,” and, to show these differences, is assigned the different reference numeral. Spectrum adjusting section 468 assigns zero values to the lower band of the whole band spectrum S(k) (0≦k<FH), because, if the decision result received from lower band component deciding section 353 is “0,” the first decoded layer spectrum S2(k) (0≦k<FL) is a mirror image of the higher band of the speech signal inputted in speech coding apparatus 400. Although this mirror image is required for the decoding process of the higher band components in filter state setting section 164, pitch filtering section 165 and gain decoding section 166, if this mirror image is included in the decoded signal and outputted directly, noise is produced and therefore the sound quality of the decoded signal degrades.

Thus, according to the present embodiment, in a case where an input signal includes higher band components alone without lower band components, downsampling section 421 performs coding by performing a extracting process directly and producing aliasing distortion in the lower band of the input signal, without performing a lowpass filtering process. By this means, upon efficiently encoding the higher band of a spectrum utilizing the lower band of the spectrum, if there are no lower band components in part of the speech signal, it is possible to further alleviate the sound quality degradation of the decoded signal.

Further, according to the present embodiment, to further alleviate the sound quality degradation of the decoded signal, downsampling section 421 of speech coding apparatus 400 may further perform an folding process of the spectrum which is produced in the lower band and which is a mirror image of the higher band of a spectrum.

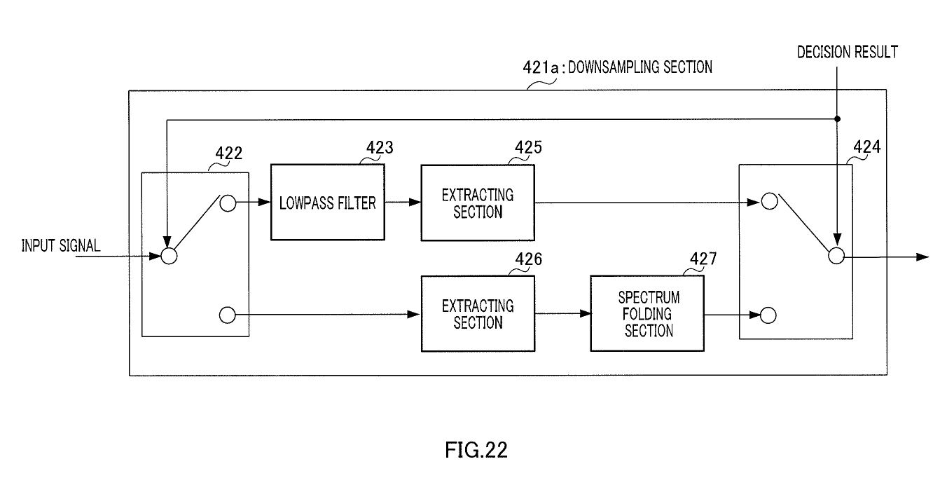

FIG. 22 is a block diagram showing downsampling section 421 employing another configuration 421a. In downsampling section 421a, the same components as in downsampling section 421 (see FIG. 17) will be assigned the same reference numerals and their explanations will be omitted.

Downsampling section 421a differs from downsampling section 421 in providing switch 424 after extracting section 425 and further having extracting section 426 and spectrum folding section 427.

Extracting section 426 differs from extracting section 425 in only an inputted signal but performs the same operations as in extracting section 425, and, consequently, detailed explanation will be omitted.

Spectrum folding section 427 performs an folding process with respect to the spectrum of the signal received from extracting section 426, and outputs the resulting signal to switch 424. To be more specific, spectrum folding section 427 folds the spectrum by performing the process according to following equation 6, with respect to the signal received from extracting section 426.

y(n)=(−1)ⁿ·x(n) (Equation 6)

In this equation, x(n) represents the input signal, y(n) represents the output signal, and the process according to this equation multiplies odd-numbered samples by −1. By this process, the spectrum is changed such that the higher frequency spectrum is folded in the lower frequency band and the lower frequency spectrum is folded in the higher frequency band.

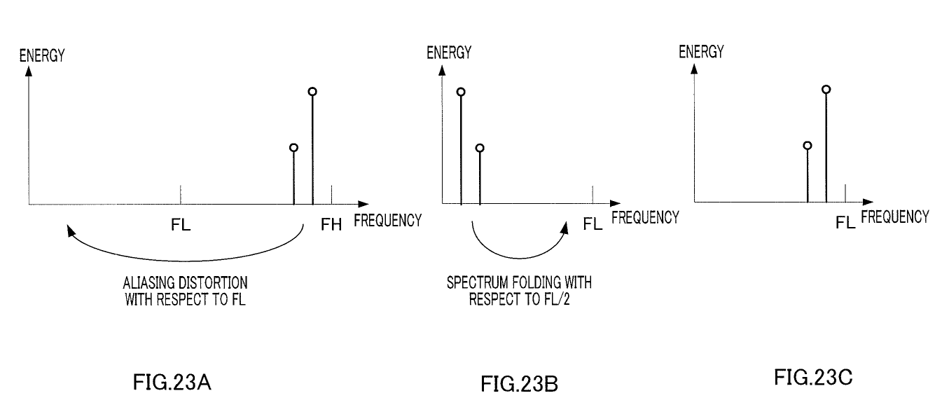

FIG. 23 illustrates how a spectrum changes in a case where downsampling section 421a does not perform a lowpass filtering process and performs a extracting process directly. FIGS. 23A and 23B are similar to FIGS. 18A and 18B, and therefore explanation will be omitted. Spectrum folding section 427 of downsampling section 421a acquires the spectrum shown in FIG. 23C by folding the spectrum shown in FIG. 23B with respect to FL/2. By this means, the lower band of the spectrum shown in FIG. 23C is more similar to the higher band of a spectrum shown in FIG. 18A or FIG. 23A than the lower band of the spectrum shown in FIG. 18B. Therefore, upon encoding the higher band of the spectrum using the lower band of the spectrum shown in FIG. 23C, it is possible to further alleviate the sound quality degradation of the decoded signal.

Further, although an example case has been described with the present embodiment where, when there are no lower band components in an input speech signal, the downsampling section does not perform a lowpass filtering process and performs a extracting process directly, it is equally possible to produce aliasing distortion by lowering the characteristics of the lowpass filter without eliminating the lowpass filtering process completely.

Embodiments of the present invention has been described above.

Further, although a case has been described with the above embodiments where, for example, multiplexing is performed in two stages on the coding side by multiplexing data in multiplexing section 118 in second layer coding section 105 and then multiplexing first layer encoded data and second layer encoded data in multiplexing section 108, the present invention is not limited to this, and it is equally possible to employ a configuration multiplexing these data together in multiplexing section 106 without multiplexing section 118.

Similarly, although a case has been described above where, for example, demultiplexing is performed in two stages on the decoding side by separating data once in demultiplexing section 151 demultiplexes and then separating second layer encoded data in demultiplexing section 161 of second layer decoding section 154, the present invention is not limited to this, and it is equally possible to employ a configuration separating these data in demultiplexing section 151 without demultiplexing section 161.

Further, frequency domain transform sections 101, 122, 124 and 172 according to the present invention can use the DFT (Discrete Fourier Transform), FFT (Fast Fourier Transform), DCT (Discrete Cosine Transform) and filter bank, in addition to the MDCT.

Further, whether a signal that is inputted in the speech coding apparatus according to the present invention is an audio signal or a speech signal, the present invention is applicable.

Further, whether a signal that is inputted in the speech coding apparatus according to the present invention is an LPC prediction residue signal instead of a speech signal or audio signal, the present invention is applicable.

Further, the speech coding apparatus and speech decoding apparatus according to the present invention are not limited to the above-described embodiments and can be implemented with various changes. Further, the present invention is applicable to scalable configurations having two or more layers.

Further, the input signal for the speech coding apparatus according to the present invention may be an audio signal in addition to a speech signal. Further, the present invention may be applied to an LPC prediction residual signal instead of an input signal.

Further, the speech coding apparatus and speech decoding apparatus according to the present invention can be mounted on a communication terminal apparatus and base station apparatus in mobile communication systems, so that it is possible to provide a communication terminal apparatus, base station apparatus and mobile communication systems having the same operational effect as above.

Although a case has been described with the above embodiments as an example where the present invention is implemented with hardware, the present invention can be implemented with software. For example, by describing the speech coding method according to the present invention in a programming language, storing this program in a memory and making the information processing section execute this program, it is possible to implement the same function as the speech coding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-299520, filed on Nov. 2, 2006, including the specification, drawings and abstract, is incorporated herein by reference in its entirety.

### INDUSTRIAL APPLICABILITY

The speech coding apparatus and so on according to the present invention are applicable to a communication terminal apparatus and base station apparatus in a mobile communication system.

1. A speech coding apparatus comprising:
a first layer coding section that encodes components in a lower band of an input speech signal and acquires first layer encoded data, the lower band being lower than a predetermined frequency;
a deciding section that decides whether or not there are the components in the lower band of the speech signal; and
a second layer coding section that, if there are the components in the lower band of the speech signal, encodes components in a higher band of the speech signal using the components in the lower band of the speech signal and acquires second layer encoded data, the higher band being equal to or higher than the predetermined frequency, and that, if there are not the components in the lower band of the speech signal, encodes the components in the higher band of the speech signal using a predetermined signal allocated in the lower band of the speech signal and acquires second layer encoded data.

2. The speech coding apparatus according to claim 1, wherein the second layer coding section comprises:
a signal generating section that, only when there are not the components in the lower band of the speech signal, generates the predetermined signal and allocates the predetermined signal in the lower band of the speech signal;
an estimating section that performs a pitch filtering process with respect to the predetermined signal allocated in the lower band of the speech signal and acquires filter information indicating an estimated spectrum of the components in the higher band of the speech signal;
a gain coding section that encodes a gain of the components in the higher band of the speech signal and acquires gain encoded data; and
a multiplexing section that multiplexes the filter information and the gain encoded data, and acquires the second layer encoded data.

3. The speech coding apparatus according to claim 2, wherein the gain coding section comprises a plurality of gain codebooks including a gain codebook that is used when there are not the components in the lower band of the speech signal and that contains gain vectors in which differences between one element and other elements are greater than the predetermined threshold.

4. The speech coding apparatus according to claim 1, wherein the deciding section decides that there are not the components in the lower band if an energy of the components in the lower band of the speech signal is lower than a first predetermined threshold, and decides that there are the components in the lower band if the energy of the components in the lower band of the speech signal is equal to or higher than the first threshold.

5. The speech coding apparatus according to claim 1, further comprising a linear prediction coefficient analysis section that performs a linear prediction coefficient analysis using the speech signal and acquires a spectral envelope of linear prediction coefficients,
wherein the deciding section decides that there are not the components in the lower band if an energy ratio is lower than a second predetermined threshold between the components in the lower band that is lower than a predetermined frequency of the spectral envelope and the components in the higher band that is equal to or higher than the predetermined frequency of the spectral envelope, and decides that there are the components in the lower band if the energy ratio is equal to or higher than the second threshold.

6. The speech coding apparatus according to claim 1, further comprising a downsampling section that directly performs a downsampling extracting process with respect to the speech signal only when there are not the components in the lower band of the speech signal, and generates a mirror image spectrum of the components in the higher band of the speech signal as the predetermined signal.

7. The speech coding apparatus according to claim 6, wherein the downsampling section folds the mirror image spectrum with respect to a frequency of half the predetermined frequency.

8. A speech decoding apparatus comprising:
a first layer decoding section that decodes a first layer encoded data acquired by encoding components in a lower band of a speech signal, the lower band being lower than a predetermined frequency;
a deciding section that decides whether or not there are the components in the lower band of the speech signal; and
a second layer decoding section that decodes second layer encoded data acquired by encoding components in a higher band of the speech signal, using the components in the lower band of the speech signal if there are the components in the lower band of the speech signal, the higher band being equal to or higher than the predetermined frequency, and that decodes the second layer encoded data acquired by encoding the components in the higher band of the speech signal, using a predetermined signal allocated in the lower band of the speech signal if there are not the components in the lower band of the speech signal.

9. A speech coding method comprising:
a first step of encoding components in a lower band of an input speech signal and acquiring first layer encoded data, the lower band being lower than a predetermined frequency;
a second step of deciding whether or not there are the components in the lower band of the speech signal; and
a third step of, if there are the components in the lower band of the speech signal, encoding components in a higher band of the speech signal using the components in the lower band of the speech signal and acquiring second layer encoded data, the higher band being equal to or higher than the predetermined frequency, and, if there are not the components in the lower band of the speech signal, encoding the components in the higher band of the speech signal using a predetermined signal allocated in the lower band of the speech signal and acquiring second layer encoded data.

10. A speech decoding method comprising:
a first step of decoding a first layer encoded data acquired by encoding components in a lower band of a speech signal, the lower band being lower than a predetermined frequency;
a second step of a deciding whether or not there are the components in the lower band of the speech signal; and
a third step of decoding second layer encoded data acquired by encoding components in a higher band of the speech signal, using the components in the lower band of the speech signal if there are the components in the lower band of the speech signal, the higher band being equal to or higher than the predetermined frequency, and decoding the second layer encoded data acquired by encoding the components in the higher band of the speech signal, using a predetermined signal allocated in the lower band of the speech signal if there are not the components in the lower band of the speech signal.
